(19) United States
(12) Patent Application Publication
(10) Pub. No.: US 2024/0418995 A1
(43) Pub. Date: Dec. 19, 2024

(54) DISPLAY DEVICE

(71) Applicant: JAPAN DISPLAY INC., Tokyo (JP)

(72) Inventors: Tetsuya OOSHIMA, Tokyo (JP); Shinichi KOMURA, Tokyo (JP); Keiji TAGO, Tokyo (JP)

(21) Appl. No.: 18/732,940

(22) Filed: Jun. 4, 2024

(30) Foreign Application Priority Data
Jun. 13, 2023 (JP) 2023-097089

(51) Int. Cl. G02B 27/01; G02B 5/30

(52) U.S. Cl. CPC G02B 27/0172; G02B 5/30; G02B 2027/0174; G02B 2027/0178

(57) ABSTRACT

According to one embodiment, a display device includes a display element, a first retardation film overlapping the display element, an optical element overlapping the display element and the first retardation film and having a lens action, a second retardation film overlapping the optical element and having a first main surface, and a reflective polarizer overlapping the second retardation film, not directly contacting the first main surface, and having a second main surface which is opposed to the first main surface and which is rotatable.

### CROSS-REFERENCE TO RELATED APPLICATIONS

This application is based upon and claims the benefit of priority from Japanese Patent Application No. 2023-097089, filed Jun. 13, 2023, the entire contents of which are incorporated herein by reference.

### FIELD

Embodiments described herein relate generally to a display device.

### BACKGROUND

In recent years, a technique for providing, for example, virtual reality (VR), using a head-mounted display worn on a user's head has attracted attention. The head-mounted display is configured to display an image on a display provided in front of the user's eyes. This allows the user wearing the head-mounted display to experience a virtual reality space with a sense of reality.

In such a display device, reduction of stray light due to undesirable reflected light has been required from the viewpoint of display quality improvement.

### BRIEF DESCRIPTION OF THE DRAWINGS

FIG. 1 is a perspective view illustrating an example of the outside of glasses 1 to which a display device DSP of a present embodiment is applied.

FIG. 2 is a diagram illustrating a configuration example of the display device DSP illustrated in FIG. 1.

FIG. 3 is a diagram illustrating a configuration example of a display element DE applicable to the display device DSP illustrated in FIG. 2.

FIG. 4 is a diagram for explaining the optical action of the display device DSP illustrated in FIG. 2.

FIG. 5 is a diagram for explaining a first axial angle θ1 and a second axial angle θ2.

FIG. 6 is a diagram illustrating a configuration example of an adjustment mechanism 3 that adjusts the rotation angle of a second transparent support body BS2.

FIG. 7 is a diagram illustrating another configuration example of the adjustment mechanism 3 that adjusts the rotation angle of the second transparent support body BS2.

FIG. 8 is a diagram for explaining reflected light at interfaces included in the display device DSP illustrated in FIG. 2.

FIG. 9 is a diagram for explaining reflected light at the interfaces included in the display device DSP as a comparative example.

FIG. 10 is a diagram illustrating another configuration example of the display device DSP illustrated in FIG. 1.

FIG. 11 is a diagram illustrating another configuration example of the display device DSP illustrated in FIG. 1.

FIG. 12 is a diagram illustrating simulation results.

### DETAILED DESCRIPTION

Embodiments described herein aim to provide a display device which can suppress degradation in display quality.

In general, according to one embodiment, a display device comprises a display element, a first retardation film overlapping the display element, an optical element overlapping the display element and the first retardation film and having a lens action, a second retardation film overlapping the optical element and having a first main surface, and a reflective polarizer overlapping the second retardation film, not directly contacting the first main surface, and having a second main surface which is opposed to the first main surface and which is rotatable.

According to the embodiments, a display device which can suppress degradation in display quality can be provided.

Embodiments will be described with reference to the accompanying drawings. Note that the disclosure is merely an example, and proper changes in keeping with the spirit of the invention, which are easily conceivable by a person of ordinary skill in the art, come within the scope of the invention as a matter of course. In addition, in some cases, in order to make the description clearer, the drawings show schematic illustration rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the drawings, in order to facilitate understanding, an X-axis, a Y-axis and a Z-axis orthogonal to each other are shown depending on the need. A direction parallel to the X-axis is referred to as a first direction X. A direction parallel to the Y-axis is referred to as a second direction Y. A direction parallel to the Z-axis is referred to as a third direction Z. The X-axis, Y-axis and Z-axis may cross each other at an angle other than 90°. Further, a plane defined by the X-axis and the Y-axis is referred to as an X-Y plane, and viewing the X-Y plane is referred to as planar view.

FIG. 1 is a perspective view illustrating an example of the outside of glasses 1 to which a display device DSP of a present embodiment is applied.

The glasses 1 comprise, for example, a display device DSPR for a right eye and a display device DSPL for a left eye. The display devices DSPR and DSPL are arranged in the second direction Y. The glasses 1, for example, can be used for the purpose of providing virtual reality or the purpose of providing augmented reality.

The display devices DSPR and DSPL have substantially the same configuration and will be described hereinafter simply as the display device DSP.

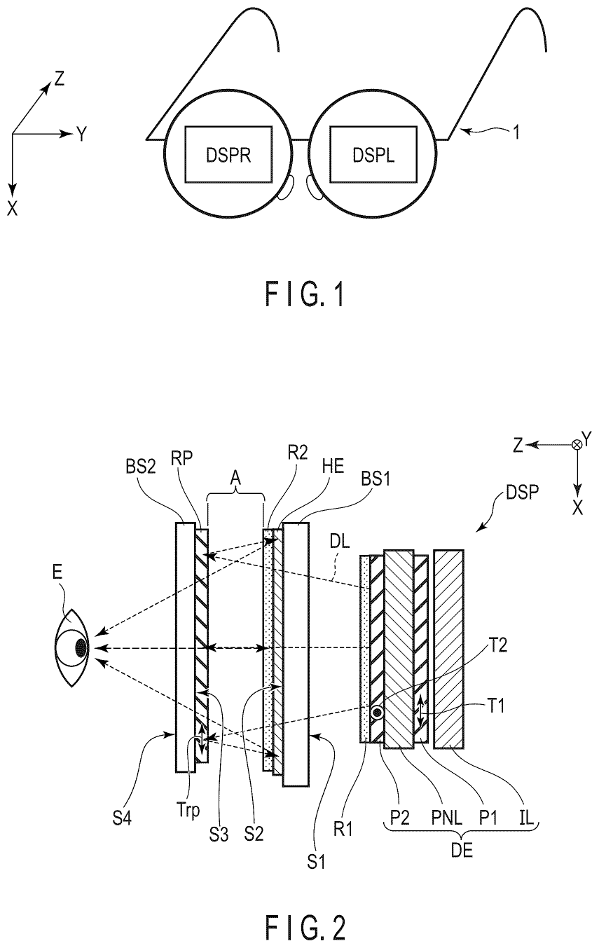

FIG. 2 is a diagram illustrating a configuration example of the display device DSP illustrated in FIG. 1.

The display device DSP comprises a display element DE, a first retardation film R1, a holographic optical element HE, a second retardation film R2, and a reflective polarizer RP. The display element DE, the first retardation film R1, the holographic optical element HE, the second retardation film R2, and the reflective polarizer RP are all formed in the shape of a flat plate along the X-Y plane. At least one of the second retardation film R2 and the reflective polarizer RP are configured to be rotatable in the X-Y plane, which will be described in detail later.

The display element DE comprises an illumination device IL, a liquid crystal panel PNL, a first polarizer P1, and a second polarizer P2. The first polarizer P1 is disposed between the illumination device IL and the liquid crystal panel PNL in the third direction Z. The liquid crystal panel PNL is disposed between the first polarizer P1 and the second polarizer P2 in the third direction Z. The transmission axis T1 of the first polarizer P1 and the transmission axis T2 of the second polarizer P2 are orthogonal to each other. For example, the transmission axis T1 is parallel to the first direction X and the transmission axis T2 is parallel to the second direction Y. The display element DE as described above is configured to emit display light DL of linearly polarized light from the second polarizer P2. The polarization axis of display light DL at the time of emission from the second polarizer P2 is parallel to the transmission axis T2. Display light DL at the time of emission from the second polarizer P2 is, for example, diverging light.

Note that the configuration of the display element DE is not limited to the example illustrated in the figure. For example, the display element DE may be a display panel comprising a self-luminous light-emitting element such as an organic electroluminescent (EL) element, a micro-LED, or a mini-LED. If the display element DE is a display panel comprising a light-emitting element, an illumination device and a first polarizer are omitted.

The first retardation film R1 overlaps the display element DE in the third direction Z. In the example illustrated in the figure, the first retardation film R1 overlaps the second polarizer P2 and is fixed to the second polarizer P2. The first retardation film R1 as described above is a quarter-wave plate and gives a quarter-wave phase difference to light of a predetermined wavelength transmitted through it. The slow axis of the first retardation film R1 crosses the transmission axis T1 of the first polarizer P1 at an angle of approximately 45°, which will be described later.

In the present specification, a state in which two members “overlap” is defined as a state in which part of one member exists on a normal of another member. In addition, the “overlap” state includes a state in which two members contact each other, a state in which two members adhere to each other, and a state in which a space or another member exists between two members.

The holographic optical element HE corresponds to an example of an optical element having a lens action. The holographic optical element HE overlaps the display element DE and the first retardation film R1 in the third direction Z. The holographic optical element HE is a resin film in which interference fringe patterns are recorded, diffracts incident light of a specific wavelength in a predetermined direction, and has the lens action of condensing incident light.

The second retardation film R2 overlaps the holographic optical element HE in the third direction Z. For example, the second retardation film R2 is disposed on the holographic optical element HE. The second retardation film R2 as described above is a quarter-wave plate and gives a quarter-wave phase difference to light of a predetermined wavelength transmitted through it. The slow axis of the second retardation film R2 crosses the transmission axis T2 of the second polarizer P2 at an angle of approximately 45° and is orthogonal to the slow axis of the first retardation film R1, which will be described later.

A first transparent support body BS1 is formed in the shape of a flat plate, and comprises a first surface S1 facing the first retardation film R1 in the third direction Z and a second surface S2 on the opposite side to the first surface S1. The first surface S1 and the second surface S2 are both flat surfaces parallel to the X-Y plane. In the example illustrated in the figure, the stacked layer body of the holographic optical element HE and the second retardation film R2 is disposed on the second surface S2.

Note that the stacked layer body of the holographic optical element HE and the second retardation film R2 may be disposed on the first surface S1. Alternatively, the holographic optical element HE and the second retardation film R2 may be disposed on the first surface S1 and the second surface S2, respectively.

The reflective polarizer RP overlaps the second retardation film R2 with an air layer A interposed therebetween in the third direction Z. As the reflective polarizer RP, a multilayered thin-film type of polarizer, a wire-grid type of polarizer, or the like is applicable. The reflective polarizer RP as described above is configured to reflect first linearly polarized light and to transmit second linearly polarized light which is different from the first linearly polarized light. The transmission axis Trp of the reflective polarizer RP and the transmission axis T2 of the second polarizer P2 are orthogonal to each other. For example, the transmission axis Trp is parallel to the first direction X, the polarization axis of first linearly polarized light is orthogonal to the transmission axis Trp, and the polarization axis of second linearly polarized light is parallel to the transmission axis Trp.

A second transparent support body BS2 is formed in the shape of a flat plate, and comprises a third surface S3 and a fourth surface S4 on the opposite side to the third surface S3. The third surface S3 and the fourth surface S4 are both flat surfaces parallel to the X-Y plane. The reflective polarizer RP is disposed on the third surface S3. Note that the reflective polarizer RP may be disposed on the fourth surface S4.

The first transparent support body BS1 and the second transparent support body BS2 are glass substrates or resin substrates.

The optical action in the display device DSP will be briefly described hereinafter.

Display light DL emitted from the display element DE is transmitted through the first retardation film R1, then transmitted through the first transparent support body BS1, the holographic optical element HE, and the second retardation film R2, and reflected by the reflective polarizer RP via the air layer A, as indicated by broken lines. Display light DL reflected by the reflective polarizer RP is transmitted through the second retardation film R2 via the air layer A, and then reflected by the holographic optical element HE. Display light DL reflected by the holographic optical element HE is transmitted through the second retardation film R2, then transmitted through the reflective polarizer RP via the air layer A, further transmitted through the second transparent support body BS2, and condensed on a user's eye E under the lens action of the holographic optical element HE.

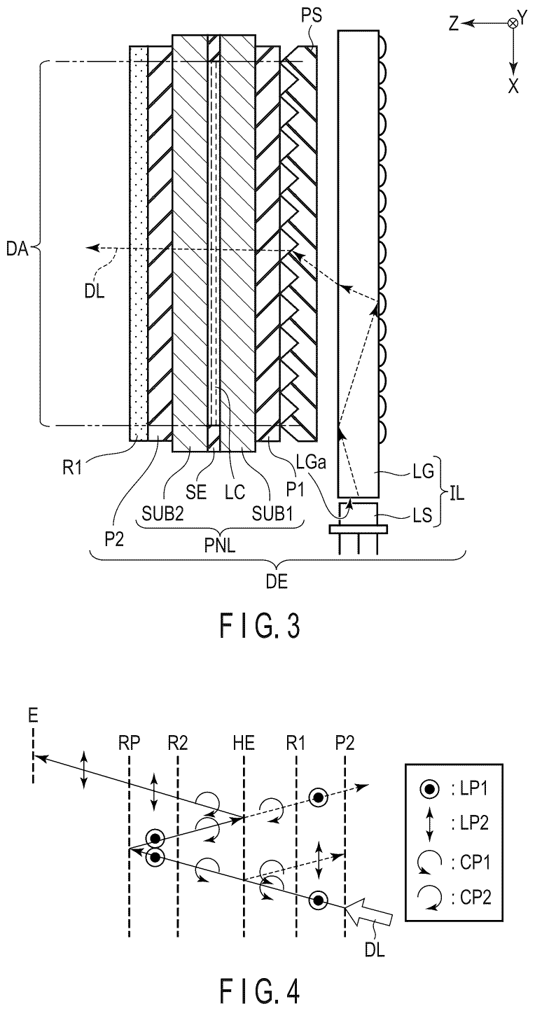

FIG. 3 is a diagram illustrating a configuration example of the display element DE applicable to the display device DSP illustrated in FIG. 2.

The display element DE comprises the liquid crystal panel PNL, the illumination device IL, a prism sheet PS. The prism sheet PS is disposed between the liquid crystal panel PNL and the illumination device IL in the third direction Z.

The liquid crystal panel PNL is a transmissive type, and comprises a first substrate SUB1, a second substrate SUB2, and a liquid crystal layer LC. The liquid crystal layer LC is held between the first substrate SUB1 and the second substrate SUB2 in the third direction Z, and is sealed by a sealant SE.

The liquid crystal panel PNL is disposed between the illumination device IL and the first retardation film R1 in the third direction Z. The first polarizer P1 is disposed between the illumination device IL and the liquid crystal panel PNL in the third direction Z and adheres to, for example, the first substrate SUB1. The second polarizer P2 is disposed between the liquid crystal panel PNL and the first retardation film R1 in the third direction Z and adheres to, for example, the second substrate SUB2.

A display portion DA is an area configured to display an image in the liquid crystal panel PNL.

The illumination device IL comprises a light guide LG and a light source LS. The light guide LG faces the prism sheet PS in the third direction Z. The light source LS faces a side surface LGa of the light guide LG in the first direction X. The light source LS comprises a light-emitting element configured to emit light of a blue wavelength, a light-emitting element configured to emit light of a green wavelength, and a light-emitting element configured to emit light of a red wavelength, though not described in detail. As these light-emitting elements, laser elements are applied, for example.

Light emitted from the light source LS is propagated while being totally reflected inside the light guide LG. Light that fails to satisfy the conditions for total reflection, of the propagated light, is emitted from the light guide LG toward the liquid crystal panel PNL. Light emitted from the light guide LG is refracted by the prism sheet PS and forms illumination light emitted in the third direction Z. The liquid crystal panel PNL selectively modulates illumination light in the display portion DA. Then, part of illumination light forms display light DL of linearly polarized light when transmitted through the second polarizer P2.

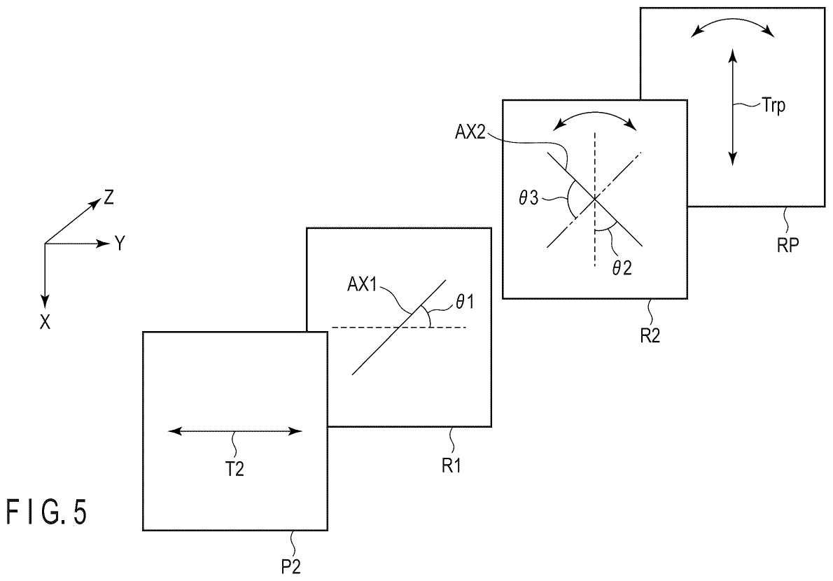

FIG. 4 is a diagram for explaining the optical action of the display device DSP illustrated in FIG. 2.

First, display light DL of first linearly polarized light LP1 transmitted through the second polarizer P2 of the display element DE is transmitted through the first retardation film R1 and converted into first circularly polarized light CP1. First circularly polarized light CP1 transmitted through the first retardation film R1 is transmitted through the holographic optical element HE and then transmitted through the second retardation film R2 to be converted into first linearly polarized light LP1. Note that first circularly polarized light CP1 reflected by the holographic optical element HE, of the first circularly polarized light CP1 transmitted through the first retardation film R1, is transmitted again through the first retardation film R1 to be converted into second linearly polarized light, and then absorbed by the second polarizer P2. Second linearly polarized light LP2 is linearly polarized light having a polarization axis orthogonal to first linearly polarized light LP1.

First linearly polarized light LP1 transmitted through the second retardation film R2 is reflected by the reflective polarizer RP. First linearly polarized light LP1 reflected by the reflective polarizer RP is transmitted through the second retardation film R2 to be converted into second circularly polarized light CP2. Second circularly polarized light CP2 is light circularly polarized in the opposite direction to that of first circularly polarized light CP1.

Second circularly polarized light CP2 transmitted through the second retardation film R2 is reflected and diffracted by the holographic optical element HE. Second circularly polarized light CP2 reflected by the holographic optical element HE is transmitted through the second retardation film R2 to be converted into second linearly polarized light LP2. Note that second circularly polarized light CP2 transmitted through the holographic optical element HE, of the second circularly polarized light CP2 transmitted through the second retardation film R2, is not reflected to the user's side and does not contribute to display.

Second linearly polarized light LP2 reflected by the holographic optical element HE and then transmitted through the second retardation film R2 is transmitted through the reflective polarizer RP, and condensed on the user's eye E under the lens action of the holographic optical element HE.

Note that first linearly polarized light LP1, which has been described with reference to FIG. 4, may be replaced by second linearly polarized light LP2, and first circularly polarized light CP1 may be replaced by second circularly polarized light CP2.

The above-described configuration example can reduce the thickness in the third direction Z, compared to that of an optical system comprising optical components formed of glass, resin, etc., and moreover, can achieve weight reduction. This enables the downsizing of the display device DSP.

Incidentally, light that has reached the eye E along an optical path different from the optical path indicated by solid lines in FIG. 4 is so-called stray light and causes degradation in display quality. From the viewpoint of stray light suppression in the example illustrated in FIG. 4, it is important for first linearly polarized light LP1 of light heading from the second retardation film R2 toward the reflective polarizer RP after being transmitted through the holographic optical element HE to be precisely orthogonal to the transmission axis Trp of the reflective polarizer RP. If first linearly polarized light LP1 of light heading from the second retardation film R2 toward the reflective polarizer RP is not precisely orthogonal to the transmission axis Trp of the reflective polarizer RP, part of the light is transmitted and stray light occurs. A factor that causes first linearly polarized light LP1 not to be precisely orthogonal to the transmission axis Trp of the reflective polarizer RP is nonconformity between a first axial angle between the transmission axis T2 of the second polarizer P2 and the slow axis of the first retardation film R1 and a second axial angle between the transmission axis Trp of the reflective polarizer RP and the slow axis of the second retardation film R2.

Thus, in the present embodiment, the second polarizer P2 and the first retardation film R1 are fixed to each other, whereas the reflective polarizer RP and the second retardation film R2 are each configured to be relatively rotatable in the X-Y plane. A more detailed description will be given below.

FIG. 5 is a diagram for explaining the first axial angle θ1 and the second axial angle θ2.

As described above, the transmission axis T2 of the second polarizer P2 is, for example, parallel to the second direction Y. The slow axis AX1 of the first retardation film R1 crosses the transmission axis T2 or the second direction Y in the X-Y plane. The first axial angle θ1 corresponds to the angle formed by the transmission axis T2 and the slow axis AX1. In order to convert first linearly polarized light LP1 transmitted through the second polarizer P2 into first circularly polarized light CP1, the first axial angle θ1 is set to 45°.

The transmission axis Trp of the reflective polarizer RP is, for example, parallel to the first direction X. The slow axis AX2 of the second retardation film R2 crosses the transmission axis Trp or the first direction X in the X-Y plane. The second axial angle θ2 corresponds to the angle formed by the transmission axis Trp and the slow axis AX2. The second axial angle θ2 is set equal to the first axial angle θ1 and here set to 45°.

Note that a third axial angle θ3 corresponding to the angle formed by the slow axis AX1 and the slow axis AX2 is set to 90°.

In order to achieve a state in which first linearly polarized light LP1 and the transmission axis Trp of the reflective polarizer RP are precisely orthogonal to each other, the first axial angle θ1 and the second axial angle θ2 need to conform to each other. For this purpose, at least one of the second retardation film R2 and the reflective polarizer RP are configured to be rotatable in the X-Y plane. If nonconformity arises between the first axial angle θ1 and the second axial angle θ2, the second axial angle θ2 can be conformed to the first axial angle θ1 by rotating at least one of the second retardation film R2 and the reflective polarizer RP. This makes it possible to suppress undesirable stray light and suppress degradation in display quality.

An example of the rotation of the second transparent support body BS2 with the reflective polarizer RP disposed thereon will be described hereinafter.

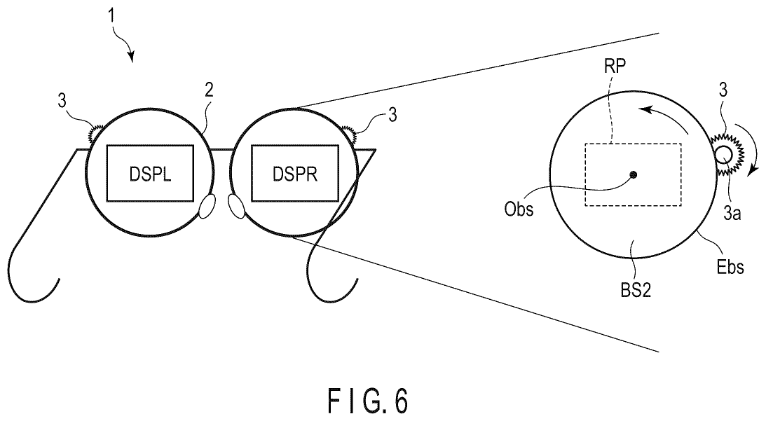

FIG. 6 is a diagram illustrating a configuration example of an adjustment mechanism 3 that adjusts the rotation angle of the second transparent support body BS2.

In the glasses 1, the display device DSPR for the right eye and the display device DSPL for the left eye are each held by a frame 2. In each of the display device DSPR and the display device DSPL, the second transparent support body BS2 with the reflective polarizer RP disposed thereon is formed in a circular shape. For example, the second transparent support body BS2 of the display device DSPR comprises a circular outer edge Ebs as illustrated in an enlarged manner. The dial-type adjustment mechanism 3 comprises a circular contact portion 3a that contacts the outer edge Ebs.

In the example illustrated in the figure, when the adjustment mechanism 3 rotates right-handed, the second transparent support body BS2 rotates on its center Obs as the axis of rotation. That is, the rotation angle of the second transparent support body BS2 can be adjusted by the adjustment mechanism 3. As the second transparent support body BS2 rotates, the reflective polarizer RP rotates. In this way, the direction in the X-Y plane of the transmission axis Trp of the reflective polarizer RP can be adjusted.

For example, in a case in which the diameter of the second transparent support body BS2 is 60 mm and the diameter of the contact portion 3a is 6 mm, when the adjustment mechanism 3 rotates 10°, the second transparent support body BS2 and the reflective polarizer RP rotate 1°.

Note that the first transparent support body BS1 with the second retardation film R2 disposed thereon is fixed to the frame 2 and does not rotate, though not illustrated in the figure.

In this way, by rotating the reflective polarizer RP with respect to the fixed second retardation film R2, a minute adjustment can be made to the second axial angle θ2 and the second axial angle θ2 can be conformed to the first axial angle θ1.

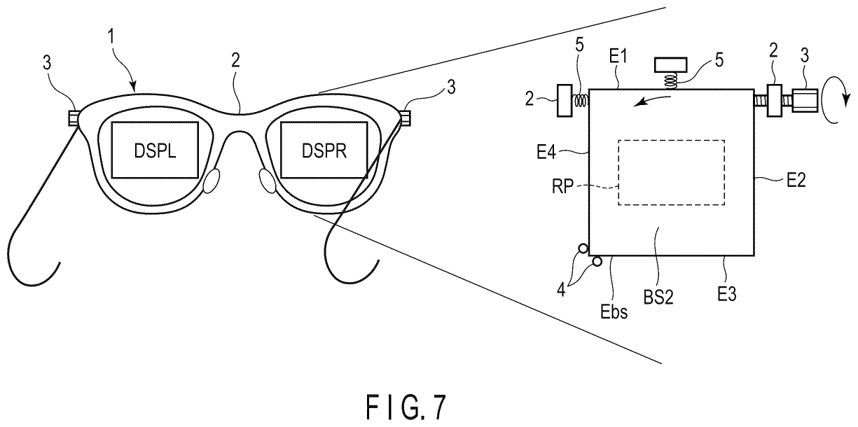

FIG. 7 is a diagram illustrating another configuration example of the adjustment mechanism 3 that adjusts the rotation angle of the second transparent support body BS2.

In each of the display device DSPR and the display device DSPL, the second transparent support body BS2 with the reflective polarizer RP disposed thereon is formed in a noncircular shape. For example, the second transparent support body BS2 of the display device DSPR is formed in a substantially quadrilateral shape and includes four edges E1 to E4 as the outer edge Ebs, as illustrated in an enlarged manner. The edge E1 is opposed to the edge E3 and the edge E2 is opposed to the edge E4.

The screw-type adjustment mechanism 3 contacts part of the edge E2 in the vicinity of the edge E1. The vicinity of the angle at which the edge E3 and the edge E4 cross contacts fixed points 4 of the frame 2. Elastic bodies 5 such as springs are interposed between the edge E1 and the frame 2 and between the edge E4 and the frame 2, respectively.

In the example illustrated in the figure, when the adjustment mechanism 3 is rotated to be pushed toward the edge E2, the second transparent support body BS2 rotates left-handed around the fixed points 4 as the axis of rotation. That is, the rotation angle of the second transparent support body BS2 can be adjusted by the adjustment mechanism 3. As the second transparent support body BS2 rotates, the reflective polarizer RP rotates. In this way, the direction in the X-Y plane of the transmission axis Trp of the reflective polarizer RP can be adjusted.

For example, in a case in which the second transparent support body BS2 is square, the edges E1 to E4 are each 50 mm in length, the screw diameter of the adjustment mechanism 3 is 2 mm, and the screw pitch of the adjustment mechanism 3 is 0.25 mm, when the adjustment mechanism 3 makes one rotation, the second transparent support body BS2 and the reflective polarizer RP rotate 0.46°.

Note that the first transparent support body BS1 with the second retardation film R2 disposed thereon is fixed to the frame 2 and does not rotate, though not illustrated in the figure.

In this way, by rotating the reflective polarizer RP with respect to the fixed second retardation film R2, a minute adjustment can be made to the second axial angle θ2 and the second axial angle θ2 can be conformed to the first axial angle θ1.

Moreover, in the respective configuration examples illustrated in FIG. 6 and FIG. 7, the first transparent support body BS1 may be configured to be rotated by the adjustment mechanism 3 with the second transparent support body BS2 fixed to the frame 2. In this case, a minute adjustment can be made to the second axial angle θ2 by rotating the second retardation film R2 with respect to the fixed reflective polarizer RP.

The influence of reflection at interfaces included in the display device DSP will be discussed next.

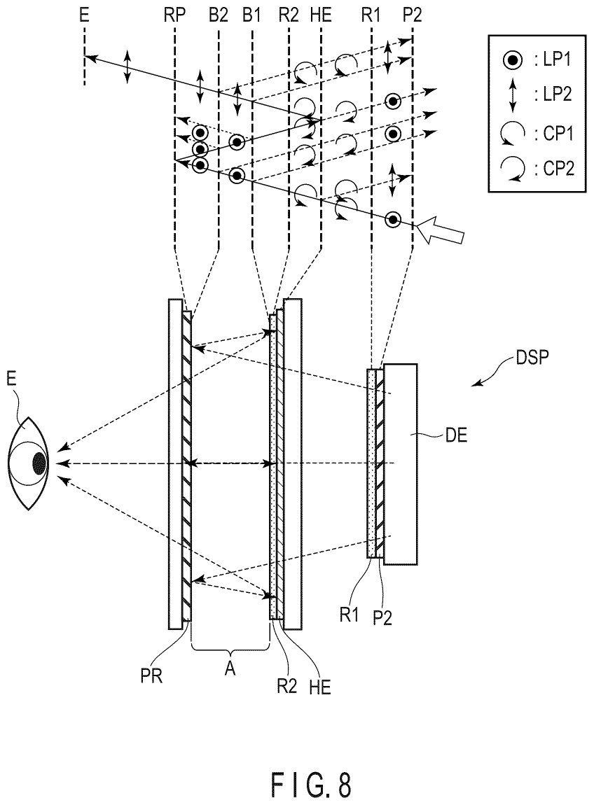

FIG. 8 is a diagram for explaining reflected light at the interfaces included in the display device DSP illustrated in FIG. 2.

The interfaces discussed here are an interface B1 between the second retardation film R2 and the air layer A and an interface B2 between the reflective polarizer RP and the air layer A.

When part of light heading from the holographic optical element HE toward the second retardation film R2 is reflected at the interface B1, the reflected light is not reflected toward the eye E and does not contribute to display.

Also when part of light heading from the second retardation film R2 toward the reflective polarizer RP is reflected at the interface B2, the reflected light also does not reach the eye E and does not contribute to display.

When part of light heading from the reflective polarizer RP toward the second retardation film R2 is reflected at the interface B2, the reflected light maintains the polarized state of first linearly polarized light, is not transmitted through the reflective polarizer RP, and does not contribute to display.

When part of light heading from the reflective polarizer RP toward the second retardation film R2 is reflected at the interface B1, the reflected light also is not transmitted through the reflective polarizer RP and does not contribute to display.

That is, according to the present embodiment, it is possible to suppress stray light due to undesirable reflection at the interfaces B1 and B2, as well as suppressing stray light due to nonconformity between the first axial angle θ1 and the second axial angle θ2.

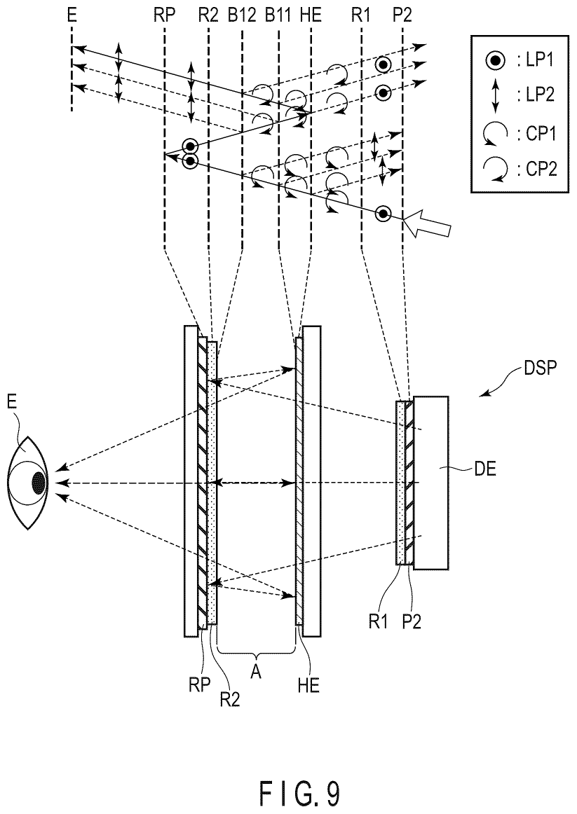

FIG. 9 is a diagram for explaining reflected light at interfaces included in the display device DSP as a comparative example.

The comparative example illustrated in the figure is different from the present embodiment illustrated in FIG. 8 in that the second retardation film R2 and the reflective polarizer RP are stacked and the air layer A is interposed between the holographic optical element HE and the second retardation film R2. The interfaces discussed here are an interface B11 between the holographic optical element HE and the air layer A and an interface B12 between the second retardation film R2 and the air layer A.

Reflected light that should be focused on here is light reflected at the interface B11 and the interface B12 of the light reflected by the reflective polarizer RP. The light reflected at the interface B11 and the interface B12 toward the reflective polarizer RP is converted into second linearly polarized light LP2 when being transmitted through the second retardation film R2. Thus, part of reflected light along an optical path other than the optical path indicated by solid lines is transmitted through the reflective polarizer RP, reaches the eye E as stray light, and causes degradation in display quality.

Furthermore, in the comparative example illustrated here, the second polarizer P2 and the first retardation film R1 are stacked, and the second retardation film R2 and the reflective polarizer RP are stacked. Thus, if nonconformity arises between the first axial angle θ1 and the second axial angle θ2, neither the first axial angle θ1 nor the second axial angle θ2 can be adjusted, which may cause further degradation in display quality.

In contrast to the above-described comparative example, the present embodiment is advantageous in that stray light can be suppressed and degradation in display quality can be suppressed.

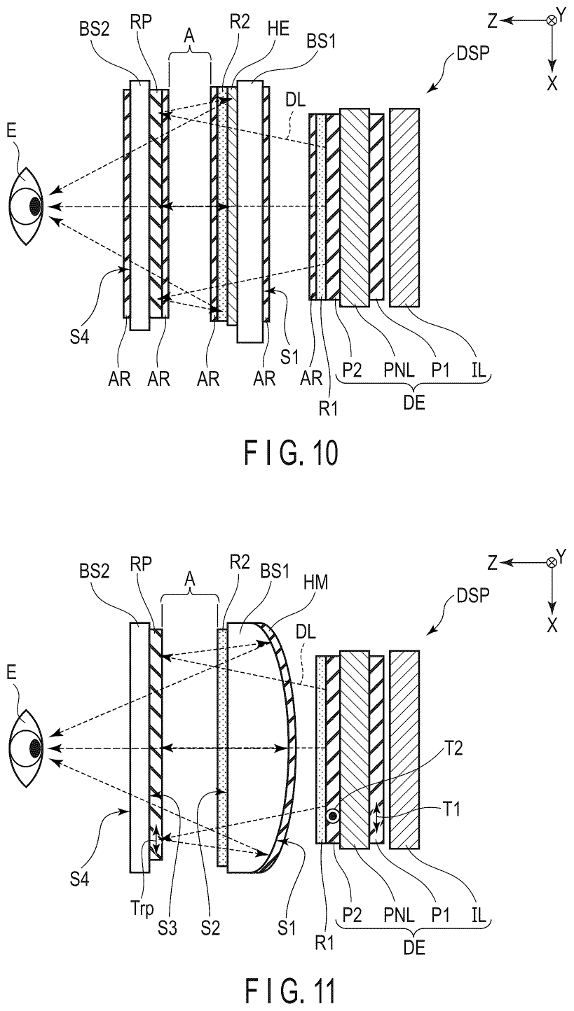

FIG. 10 is a diagram illustrating another configuration example of the display device DSP illustrated in FIG. 1.

The configuration example illustrated in FIG. 10 is different from the configuration example illustrated in FIG. 2 in that the first retardation film R1, the second retardation film R2, and the reflective polarizer RP are covered with anti-reflective layers AR, respectively. In the example illustrated in the figure, the first surface S1 of the first transparent support body BS1 and the fourth surface S4 of the second transparent support body BS2 are also covered with anti-reflective layers AR, respectively.

According to the configuration example illustrated in FIG. 10, undesirable reflection is suppressed at the interface between the first retardation film R1 and an air layer, the interface between the first surface S1 and an air layer, the interface between the second retardation film R2 and an air layer, the interface between the reflective polarizer RP and an air layer, and the interface between the fourth surface S4 and an air layer. Accordingly, degradation in display quality can be suppressed.

FIG. 11 is a diagram illustrating another configuration example of the display device DSP illustrated in FIG. 1.

The configuration example illustrated in FIG. 11 is different from the configuration example illustrated in FIG. 2 in that as an optical element having a lens action, the holographic optical element HE is replaced by a transflective layer (half mirror) HM whose side facing the second retardation film R2 is formed in a concave shape.

In the example illustrated in the figure, the first transparent support body BS1 is formed as a plano-convex lens. That is, in the first transparent support body BS1, the first surface S1 is formed as a convex surface, and the second surface S2 is formed as a flat surface parallel to the X-Y plane. The transflective layer HM is disposed on the first surface S1. The second retardation film R2 is disposed on the second surface S2.

The optical action in the display device DSP will be briefly described hereinafter.

Display light DL emitted from the display element DE is transmitted through the first retardation film R1, then transmitted through the transflective layer HM, further transmitted through the first transparent support body BS1 and the second retardation film R2, and reflected by the reflective polarizer RP via the air layer A, as indicated by broken lines. Display light DL reflected by the reflective polarizer RP is transmitted through the second retardation film R2 and the first transparent support body BS1 via the air layer A, and then reflected by the transflective layer HM. Display light DL reflected by the transflective layer HM is transmitted through the first transparent support body BS1 and the second retardation film R2, then transmitted through the reflective polarizer RP via the air layer A, further transmitted through the second transparent support body BS2, and condensed on the user's eye E under the lens action of the transflective layer HM.

In this configuration example, too, the same advantages as those of the above-described configuration examples can be achieved.

As in the configuration example illustrated in FIG. 10, the anti-reflective layers AR may be applied, though not illustrated in the figure.

Next, the inventors tested the influence of nonconformity between the first axial angle θ1 and the second axial angle θ2 by a simulation.

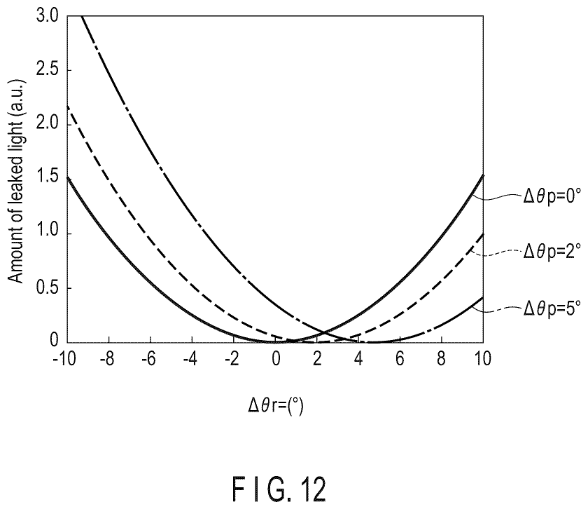

FIG. 12 is a diagram illustrating simulation results.

The conditions for the simulation are as follows. The direction in the X-Y plane of the transmission axis T2 of the second polarizer P2 is used as a standard, and the transmission axis T2 is set to the direction of 0°. The slow axis AX1 of the first retardation film R1 is set to the direction of 45° and the first axial angle θ1 is set to 45°.

The direction of 135° is set as the design value of the slow axis AX2 of the second retardation film R2, and the amount of deviation from the design value is expressed as Δθr.

The direction of 90° is set as the design value of the transmission axis Trp of the reflective polarizer RP, and the amount of deviation from the design value is expressed as Δθp.

The retardations Δn·d of the first retardation film R1 and the second retardation film R2 are both 144 nm, where Δn is a parameter indicating refractive anisotropy or birefringence in each retardation film and d corresponds to the thickness of each retardation film.

The horizontal axis of FIG. 12 represents the amount of deviation Δθr (°) and the vertical axis represents the amount of leaked light (a.u.). As described with reference to FIG. 9, leaked light refers to undesirable stray light due to nonconformity between the second axial angle θ2 and the first axial angle θ1, and corresponds light transmitted through the reflective polarizer RP and reaching the eye E.

A solid line in the figure represents the simulation result of the amount of leaked light when the amount of deviation Δθp is 0°. In a case in which the amount of deviation Δθr is 0°, the second axial angle θ2 is equal to the first axial angle θ1, and is 45°. In this case, the amount of leaked light is the smallest. It has been confirmed that as the absolute value of the amount of deviation Δθr increases, the difference between the first axial angle θ1 and the second axial angle θ2 increases and the amount of leaked light increases.

A broken line in the figure represents the simulation result of the amount of leaked light when the amount of deviation Δθp is 2°. In a case in which the amount of deviation Δθr is 2°, the second axial angle θ2 is equal to the first axial angle θ1, and is 45°. In this case, the amount of leaked light is the smallest. It has been confirmed that as the amount of deviation Δθr becomes greater than 2° or less than 2°, the difference between the first axial angle θ1 and the second axial angle θ2 increases and the amount of leaked light increases.

An alternate long and short dashed line in the figure represents the simulation result of the amount of leaked light when the amount of deviation Δθp is 5°. In a case in which the amount of deviation Δθr 5°, the second axial angle θ2 is equal to the first axial angle θ1, and is 45°. In this case, the amount of leaked light is the smallest. It has been confirmed that as the amount of deviation Δθr becomes greater than 5° or less than 5°, the difference between the first axial angle θ1 and the second axial angle θ2 increases and the amount of leaked light increases.

As described above, according to the present embodiment, a display device which can suppress degradation in display quality can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display element;
a first retardation film overlapping the display element;
an optical element overlapping the display element and the first retardation film and having a lens action;
a second retardation film overlapping the optical element and having a first main surface; and
a reflective polarizer overlapping the second retardation film, not directly contacting the first main surface, and having a second main surface which is opposed to the first main surface and which is rotatable.

2. The display device of claim 1, wherein
the first retardation film and the second retardation film are quarter-wave plates, and
the reflective polarizer is configured to reflect first linearly polarized light and to transmit second linearly polarized light which is different from the first linearly polarized light.

3. The display device of claim 1, wherein
the display element comprises an illumination device, a liquid crystal panel disposed between the illumination device and the first retardation film, a first polarizer disposed between the illumination device and the liquid crystal panel, and a second polarizer disposed between the liquid crystal panel and the first retardation film.

4. The display device of claim 1, wherein
the optical element is a holographic optical element and is configured to reflect light reflected by the reflective polarizer toward the reflective polarizer.

5. The display device of claim 1, wherein
the optical element is a transflective layer whose side facing the second retardation film is formed in a concave shape, and is configured to reflect light reflected by the reflective polarizer toward the reflective polarizer.

6. The display device of claim 1, further comprising:
a first transparent support body on which the optical element and the second retardation film are disposed; and
a second transparent support body on which the reflective polarizer is disposed.

7. The display device of claim 1, wherein
the first retardation film, the second retardation film, and the reflective polarizer are covered with anti-reflective layers, respectively.

8. The display device of claim 6, further comprising an adjustment mechanism that is configured to a rotation angle of one of the first transparent support body and the second transparent support body.

9. The display device of claim 8, wherein
one of the first transparent support body and the second transparent support body is formed in a circular shape, and
the adjustment mechanism is configured to rotate the reflective polarizer around a center of one of the first transparent support body and the second transparent support body as an axis of rotation.

10. The display device of claim 8, wherein
the adjustment mechanism is configured to rotate the reflective polarizer around a fixed point that contacts an outer edge of one of the first transparent support body and the second transparent support body as an axis of rotation.

11. The display device of claim 8, wherein
one of the first transparent support body and the second transparent support body is formed in a circular shape, and
the adjustment mechanism is configured to rotate the second transparent support body around a center of one of the first transparent support body and the second transparent support body as an axis of rotation.

12. The display device of claim 8, wherein
the adjustment mechanism is configured to rotate the second transparent support body around a fixed point that contacts an outer edge of one of the first transparent support body and the second transparent support body as an axis of rotation.

13. The display device of claim 1, wherein
the display element is configured to emit display light of linearly polarized light.

14. The display device of claim 1, wherein
a whole reflective polarizer is rotatable with respect to the first main surface.
